(19) United States
(12) Patent Application Publication
(10) Pub. No.: US 2014/0064652 A1
(43) Pub. Date: Mar. 6, 2014

(54) BEARING SUPPORT

(71) Applicant: Aktiebolaget SKF, Goteborg (SE)

(72) Inventors: Berthold Beyfuss, Wasserlosen-Kaisten (DE); Burkhard Buchheim, Schweinfurt (DE); Alexander Dilje, Schweinfurt (DE); Hans-Juergen Friedrich, Konigsberg-Romershofen (DE); Helmut Hauck, Euerbach (DE); Holger Kristandt, Euerbach (DE); Alfred Radina, Poppenlauer (DE); Jonas Schierling, Hassfurt (DE)

(73) Assignee: Aktiebolaget SKF, Goteborg (SE)

(21) Appl. No.: 14/015,392

(22) Filed: Aug. 30, 2013

Related U.S. Application Data
(63) Continuation of application No. 13/063,082, filed on May 26, 2011, now abandoned.

(30) Foreign Application Priority Data
Sep. 9, 2008 (DE) 10 2008 046 482.1

(51) Int. Cl. F16C 35/06

(52) U.S. Cl. CPC F16C 35/061
USPC 384/548

(57) ABSTRACT

A bearing support is configured to retain at least two bearings disposed closely adjacent to each other in a parallel relationship. Each bearing includes a bearing outer ring having a cylindrical outer circumferential surface. A support part includes a recess configured to hold the at least two bearings. At least one junction portion is defined in the support part adjacent portions of the cylindrical circumferential surfaces of the bearings that are not filled by the bearings when the bearings are inserted into the support part. The support part is connected with a cover part that axially abuts on the bearings. The cover part includes at least one support element that extends into the junction portion between the bearings in the assembled state of the bearing support and at least partially fills the junction portion.

### CROSS-REFERENCE

This application is a continuation of U.S. patent application Ser. No. 13/063,082, filed May 26, 2011, the entire contents of which are hereby incorporated by reference. U.S. patent application Ser. No. 13/063,082, in turn, is the U.S. national stage of International Application No. PCT/EP2009/006502 filed on Sep. 8, 2009, which claims priority to German patent application no. 10 2008 046 482.1 filed on Sep. 9, 2008.

### TECHNICAL FIELD

The invention relates to a bearing support for retaining at least two adjacently-disposed bearings, wherein the rotational axes of the at least two bearings are parallel and spaced relative to one another, wherein each bearing includes a bearing outer ring having a cylindrical circumferential surface, wherein the bearing support comprises a support part, into which a recess provided for holding the at least two bearings is fowled, wherein the recess includes, in addition to cylindrical holding portions, at least one junction portion only for one portion of the cylindrical circumferential surface of the bearings, which junction portion is not filled by the bearings when the bearings are inserted into the support part, and wherein the support part is connected with a cover part that axially abuts on the bearings.

### RELATED ART

A bearing support of this type is known from EP 1 072 806 B1. There, a plate, which should form the bearing support, is provided with two pot-shaped recesses for the two to-be-held bearings by deep-drawing. After the bearings are inserted into the recesses, a cover part is welded on and ensures that the bearings are disposed in the bearing support so as to be fixed in both axial directions. As a result, radial bearing forces are supported by radially supporting the outer rings of the bearing on the cylindrical surfaces of the deep-drawn recesses; axial bearing forces are absorbed (in the one axial direction) by the cover part.

In this way, it is possible to support two roller bearings closely adjacent to each other with the rotational axes oriented parallel to each other. Such a bearing is necessary, e.g., in transmissions when two transmission shafts must be supported close to each other.

Due to the geometrical relationships, the entire circumference of the abutment surface of the bearing seat is not available when the bearings move closer and closer together. Moreover, a spandrel-like imperfection (which is identified above as the junction portion) is created at the point where the bearings are the closest to one another, which imperfection does not ensure a radial support of the bearing. In the case of closely-adjacent bearings, it is also disadvantageous that the bearing support does not provide a completely-enclosed radial bearing guide in the area of the bearing seat. A 360° encircling support of the bearing does not result in the radial direction, because the small axial spacing and the manufacturing process of the bearing support (in most cases, by deep-drawing) cannot realize it. Consequently, high shape- and positional imprecisions of the bearing seat are possible in the bearing support, which can adversely affect the useful life of the bearing. Depending on the application, in case a complete radial support of the bearing is required, it cannot be ensured by known bearing supports. The current trend towards minimizing the installation space leads to axial spacings that, in case of deep-drawn recesses of a bearing support, do not allow for a 360° encircling bearing seat.

### SUMMARY

In one aspect of the present teachings, an improved bearing support is disclosed, which may overcome one or the above-mentioned disadvantages. In such embodiments of the present teachings, the bearing support can be manufactured in a simple, reliable and/or cost-efficient manner In addition or in the alternative, a stable radial guidance of the bearing is also possible over at least nearly the entire circumference of the bearing outer ring, which is especially advantageous when bearings are disposed closely together. Further, the bearings are axially supported in the bearing support.

[6] In another aspect of the present teachings, a cover part is provided for the bearing support includes at least one support element, which extends into a junction portion between two bearings in the assembled state of the bearing support and at least partially fills the junction portion.

The support element can include radial abutment surfaces for a portion of the cylindrical circumferential surface of the bearing outer rings. In this case, it is preferably provided that the cylindrical holding portions of the recesses in the support part and the abutment surfaces of the support element complement each other to form a radial support for the bearing outer rings, which radial support extends to a large extent, preferably completely, around the entire circumference of the bearing outer ring.

In another aspect of the present teachings, the cover part and the support element may be formed as one-piece. In this case, the support element is preferably formed on the cover part by a deep-drawing process. However, it is also possible, e.g., that the cover part and the support element are formed together as a cast part.

It can, however, also be advantageous if the cover part and the support element are separate parts that are connected with each other. In this connection, the support element can include, e.g., at least one pin-shaped extension that passes through at least one bore in the cover part; the pin-shaped extension can be a rivet. The cover part and the support element can be connected with each other by a material bonding connection, in particular by welding, by soldering and/or by adhesive.

The support element can be formed as a solid body. In the alternative, it can also be provided that the support element is formed as a hollow body. In the latter case, the support element can be formed as a bridge-shaped wall.

The recesses in the support part for holding the bearings are produced, in most cases, by a deep-drawing process.

The cover part can have—as observed in the direction of the rotational axes of the Bearing—the shape of an eight.

The support element can be comprised of metal, in particular sintered metal, or plastic.

The invention thus provides the integration of a supplemental radial support, which is provided by the cover part. As a result, it is possible to radially support the bearing practically around the entire circumference, i.e. over the 360° circumferential angle. An improved roundness of the bearing track results after the assembly into the bearing support unit and thus a longer useful life of the bearing.

The cover part, which is employed in the representative design, is thus already equipped with another functionality that enables the above-mentioned effect to be realized in a cost-effective manner.

The proposed solution is preferably utilized in transmissions, wherein automobile transmissions, in particular, come into consideration. However, the proposed solution can also be utilized in other applications, in which two bearings must be supported close to one another.

Exemplary embodiments of the invention are illustrated in the drawings.

### BRIEF DESCRIPTION OF THE DRAWINGS

FIG. 1 shows a completely-assembled bearing support in perspective illustration,

FIG. 2 shows a cut-out of the bearing support according to FIG. 1, however with the cover part removed.

FIG. 3 shows the cover part of the bearing support in perspective illustration, wherein the side that faces the bearings can be seen above,

FIG. 4 shows a cover part in an alternative design in the illustration according to FIG. 3,

FIG. 5 shows a cover part in another alternative design in the illustration according to FIGS. 3 and

FIG. 6 shows the cover part according to FIG. 5 rotated by 180°, i.e. the side that faces away from the bearing can be seen above.

### DETAILED DESCRIPTION

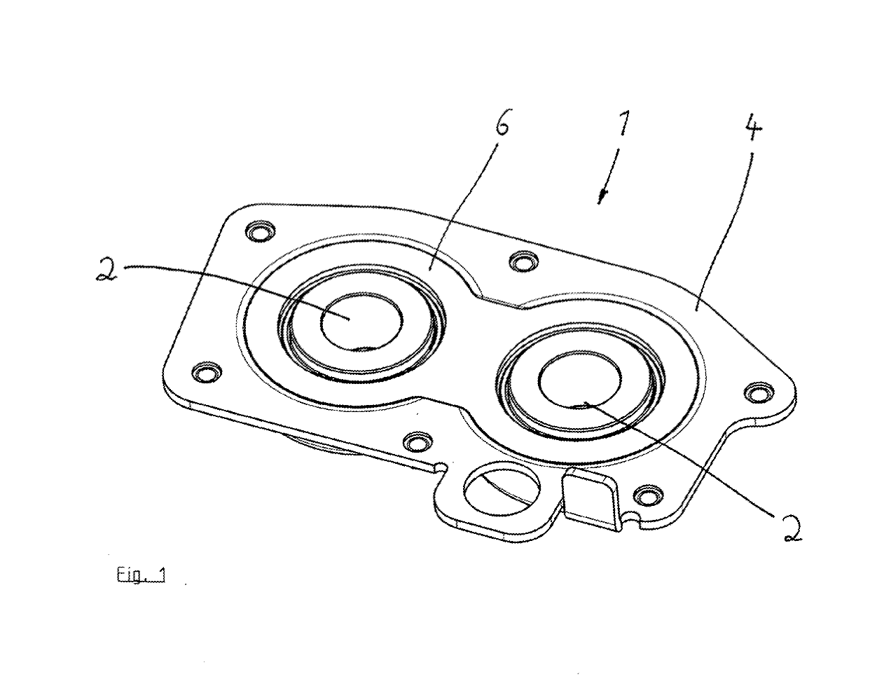

In FIG. 1, a bearing support 1 is illustrated, which is intended to support two closely-spaced roller bearings 2 having rotational axes that are oriented so as to be parallel to one another. This assembly is typical for an automobile transmission, in which two shafts must be supported so as to be parallel to one another with a small clearance. The bearing support 1 is comprised of two parts 4 and 6. The first part 4 is a support part that is comprised of a plate, into which a holder for the two bearings 2 is formed by a deep-drawing process. The bearing support is closed in the upward direction by the second part 6 in the form of a cover part. The cover part 6 ensures that the bearings 2 can not fall out of the recesses in the support part 4 in the upward direction.

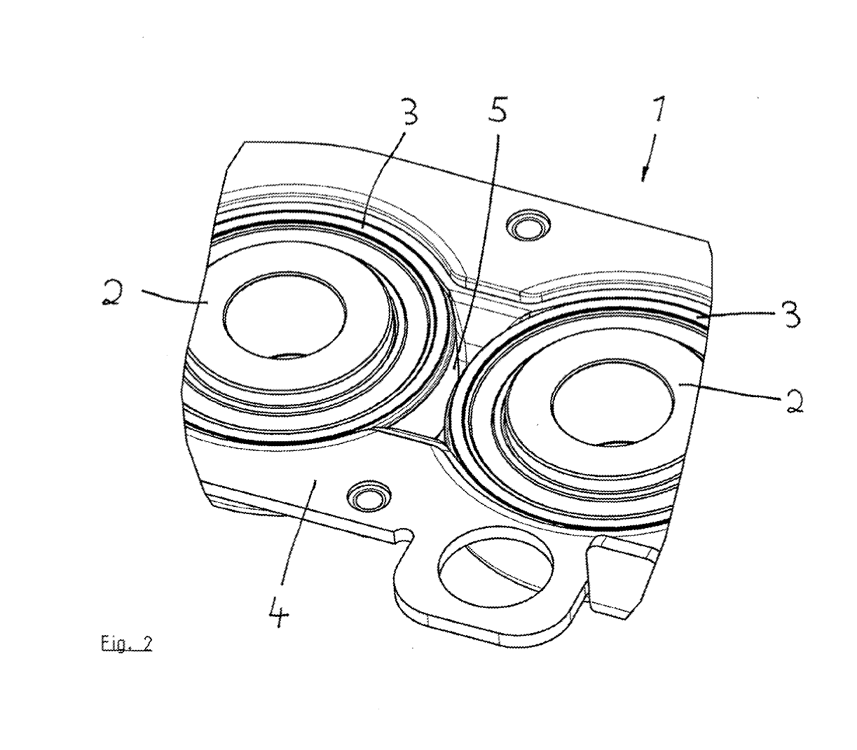

The design of the support part 4 can be seen in FIG. 2, in which the cover part 6 is not illustrated. The bearing outer rings 3 of the two bearings 2 are inserted into the deep-drawn recesses in the support part 4. Because the two bearings 2 are to be positioned with a relatively small clearance, a junction portion 5 results in the recess. The outer rings 3 of the bearings 2 are not radially supported in this junction portion.

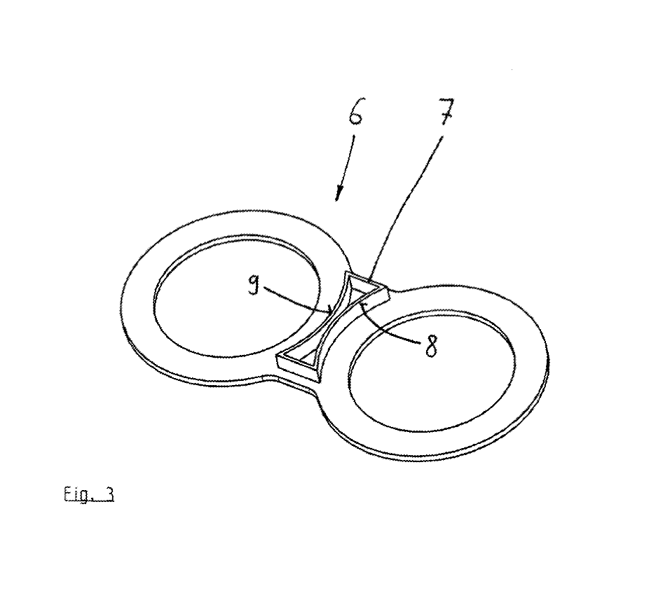

So that this radial support of the outer rings 3 is also possible in the junction portion 5, the cover part 6 is designed as can be seen in an exemplary manner in FIGS. 3 to 6.

In FIG. 3, it can be seen that a support element 7 in the form of a radially-encircling bridge is disposed on the cover part 6 and is produced by deep-drawing the plate of the cover part 6. As a result, the support element 7 is formed so that it has analogously-formed radial abutment surfaces S and 9 formed on the side that is facing towards the bearing outer rings 3 in the assembled state. As a result, the support element 7 supports the bearing outer rings 3 also in the circumferential portions where this would not be possible otherwise.

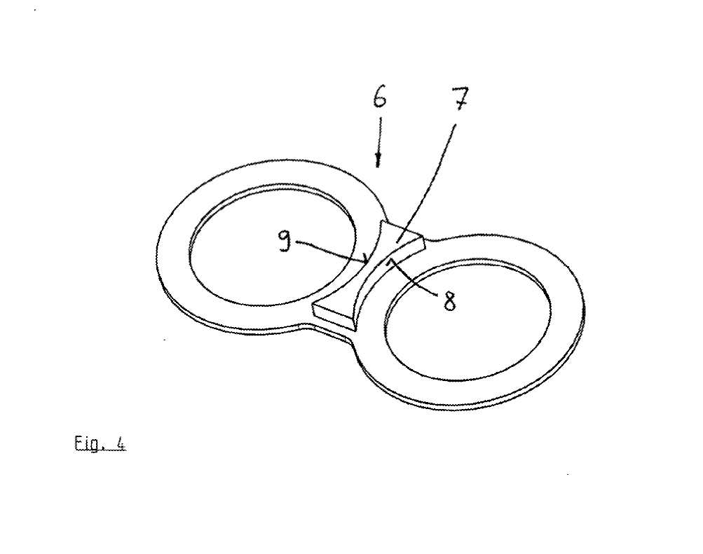

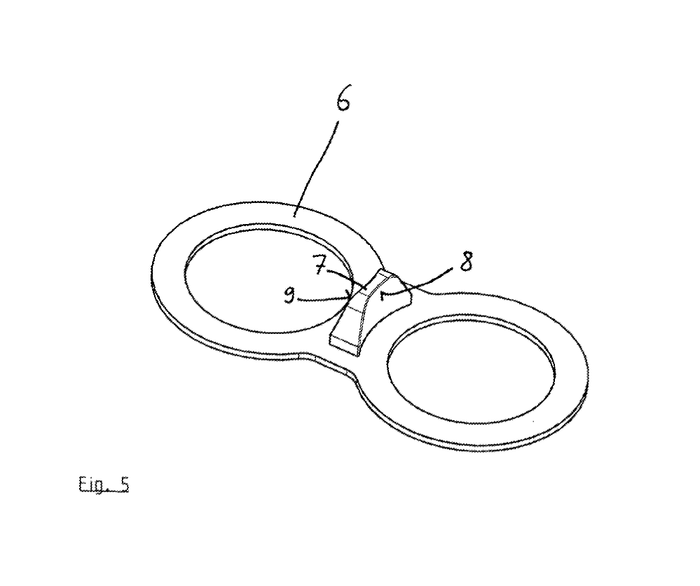

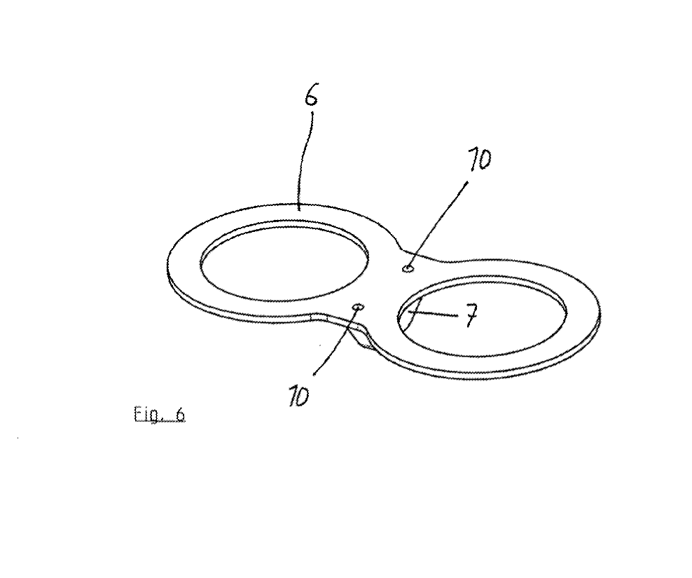

In FIG. 4, it can be seen that the support element 7 can also be formed in a solid manner. In this case, the cover part 6 has been at least partially produced by a cutting process, wherein the support element 7 has been “allowed to remain standing”.

Whereas FIGS. 3 and 4 show a solution, in which the cover part 6 and the support element 7 are formed in a one-piece manner, an alternative can be seen in FIGS. 5 and 6, in which separate parts are provided as the two parts 6 and 7, which are connected with each other after being manufactured. In principle, all connection technologies are available for the connection, i.e. interlocking-fit, friction-fit and material bonding connections.

In the present case, the support element 7 includes pin-shaped extensions 10 in the form of rivets that pass through the bores, which are formed into the cover part 6, see FIG. 6.

In this case, the cover part 6 and the support element 7 can be comprised of different materials. For example, the cover part 6 can be comprised of steel plate and the support element can be comprised of plastic or sintered metal.

According to the invention, the cover element 6 required for the axial fixing of the bearings 2 is designed to fulfill the function of the radial guide of the bearing outer rings 3. Consequently, an enclosure of the bearings 2 around practically 360° (and/or nearly around) 360° is possible.

Preferred variants for the design of the cover part 6 and the support element 7 are:
one-piece deep-drawn part made from a plate;
one-piece part produced by cutting;
one- or multiple-piece part having portions made from metallic sintered materials;
one- or multiple-piece part having portions made from plastic materials;
one- or multiple-piece part having metallic portions produced by casting;
cover part having an enclosed axial abutment surface for the bearing;
cover plate having a segmented, not enclosed axial abutment surface for the bearing.

### Reference Number List

1 bearing support
2 bearing (roller bearing)
3 bearing outer ring
4 support part
5 junction portion
6 cover part
7 support element
8 radial abutment surface
9 radial abutment surface
10 pin-shaped extension (rivet)

1-17. (canceled)

18. A bearing support configured to retain at least two adjacently-disposed bearings, wherein respective rotational axes of the at least two bearings are parallel and each bearing includes a bearing outer ring having a cylindrical outer circumferential surface, the bearing support comprising:
a support part having a recess defined by at least two cylindrical holding portions configured to respectively hold the at least two bearings and at least one junction portion disposed between the two cylindrical holding portions, the at least one junction portion being proximal to adjacent portions of the cylindrical outer circumferential surfaces of the bearings when the bearings are inserted into the support part, and
a cover part connected to the support part and configured to axially abut the at least two bearings, the cover part including at least one support element that extends into and at least partially fills the at least one junction portion, wherein the cover part and the support element are formed as one piece.

19. A bearing support according to claim 18, wherein the support element includes radial abutment surfaces configured to respectively abut the adjacent portions of the cylindrical outer circumferential surfaces of the bearing outer rings when the bearings are inserted into the support part.

20. A bearing support according to claim 19, wherein the cylindrical holding portions and the radial abutment surfaces complement each other to form respective radial supports for the bearing outer rings, each radial support extending at least substantially completely around the entire circumference of the respective bearing outer ring.

21. A bearing support according to claim 18, wherein the support element is formed as a solid body.

22. A bearing support according to claim 18, wherein the support element is formed as a hollow body.

23. A bearing support according to claim 22, wherein the support element includes a first arc-shaped wall and a second arc-shaped wall.

24. A bearing support according to claim 18, wherein the recess is formed in the support part by deep-drawing.

25. A bearing support according to claim 18, wherein the cover part has the shape of a figure eight as observed in the direction of the rotational axes of the bearings.

26. A bearing assembly comprising:
a first bearing and a second bearing adjacently-disposed and oriented such that rotational axes of the first bearing and the second bearing are parallel, each bearing including a bearing outer ring having a cylindrical outer circumferential surface,
a support part having a recess defined by:
a first cylindrical seating portion and a second cylindrical seating portion retaining and at least substantially radially supporting the respective bearing outer rings of the first bearing and the second bearing and
at least one junction portion defined between the first cylindrical seating portion and the second cylindrical seating portion, the at least one junction portion being proximal to adjacent portions of the cylindrical outer circumferential surfaces of the bearing outer rings, and
a cover part fixedly connected to the support part to retain the first bearing and the second bearing and axially abutting the first bearing and the second bearing, the cover part including at least one support element that extends into and at least partially fills the at least one junction portion, wherein the cover part and the support element are formed as one piece.

27. A bearing assembly according to claim 26, wherein the support element includes a first radial abutment surface and a second radial abutment surface configured to abut and radially support the respective adjacent portions of the cylindrical circumferential surfaces of the bearing outer rings.

28. A bearing assembly according to claim 27, wherein:
the first cylindrical seating portion and the first radial abutment surface complement each other so as to extend at least substantially continuously around the entire cylindrical circumferential surface of the bearing outer ring of the first bearing and provide an at least substantially complete radial support for the first bearing, and
the second cylindrical seating portion and the second radial abutment surface complement each other so as to extend at least substantially continuously around the entire cylindrical circumferential surface of the bearing outer ring of the second bearing and provide an at least substantially complete radial support for the second bearing.

29. A bearing assembly according to claim 28, wherein the cover part has the shape of a figure eight as observed in the direction of the rotational axes of the first and second bearings.

30. A bearing assembly according to claim 29, wherein:
the support element is formed as a hollow body extending substantially perpendicularly from the cover part,
the first radial abutment surface and the second radial abutment surface define an arc of a circular cylinder,
the first cylindrical seating portion and the first radial abutment surface completely surround and radially support the first bearing, and
the second cylindrical seating portion and the second radial abutment surface completely surround and radially support the second bearing.

31. A bearing support configured to retain at least two adjacently-disposed bearings, wherein respective rotational axes of the at least two bearings are parallel and each bearing includes a bearing outer ring having a cylindrical outer circumferential surface, the bearing support comprising:
a support part having a recess defined by at least two cylindrical holding portions configured to respectively hold the at least two bearings and at least one junction portion disposed between the two cylindrical holding portions, the at least one junction portion being proximal to adjacent portions of the cylindrical outer circumferential surfaces of the bearings when the bearings are inserted into the support part, and
a cover part connected to the support part and configured to axially abut the at least two bearings, the cover part including at least one deep-drawn projection extending into and at least partially fills the at least one junction portion.

32. A bearing support according to claim 31, wherein the at least one deep-drawn projection is integrally formed with the cover.

33. An automobile transmission including a bearing support according to claim 31.
